(19) United States
(12) Patent Application Publication
(10) Pub. No.: US 2018/0048500 A1
(43) Pub. Date: Feb. 15, 2018

(54) DEMODULATOR

(71) Applicant: Asahi Kasei Microdevices Corporation, Tokyo (JP)

(72) Inventor: Narutomo TANAKA, Tokyo (JP)

(21) Appl. No.: 15/792,768

(22) Filed: Oct. 25, 2017

Related U.S. Application Data
(63) Continuation of application No. PCT/JP2016/074414, filed on Aug. 22, 2016.

(30) Foreign Application Priority Data
Aug. 31, 2015 (JP) 2015-170720

(51) Int. Cl. H04L 27/14; H04B 1/00; H04B 1/10; H04B 1/12

(52) U.S. Cl. CPC H04L 27/14; H04B 1/12; H04B 1/0021; H04B 1/1027

(57) ABSTRACT

A demodulator 100 includes: an AD conversion section 10 that converts a received signal RF in an analogue form to a digital signal; a noise removal section 40 that is connected to a back side of the AD conversion section 10 to detect and remove a noise from an input signal; decimation filters 52 and 54 that are connected to a back side of the noise removal section 40 and reduce a data rate of an input signal; and a demodulation section 60 that is connected to back sides of the decimation filters 52 and 54 and demodulates an input signal. The decimation filters 52 and 54 are connected to the back side of the noise removal section 40, which provides a demodulator less subject to degradation of a signal wave.

The contents of the following Japanese patent application are incorporated herein by reference:
NO. 2015-170720 filed in JP on Aug. 31, 2015.
NO. PCT/JP2016/074414 filed on Aug. 22, 2016.

### BACKGROUND

### 1. Technical Field

The present invention relates to a demodulator.

### 2. Related Art

One of modulation schemes for modulating a signal such as an audio signal to a radio wave is frequency modulation (FM modulation) for changing a frequency of a carrier wave in accordance with amplitude of a signal wave. A signal that is FM modulated (FM signal) is demodulated in the following steps: in a demodulator, passing a received signal through an AD converter to convert the signal to a digital signal; subsequently passing the signal through a decimation filter to lower a sampling rate; and then passing the signal through a demodulator (for example, refer to Non-Patent Document 1).

In particular, for a demodulator equipped in a vehicle, it is necessary to remove pulse noises mixed into a radio wave in demodulation of an FM signal. That is because a vehicle is equipped with electric windows, electric mirrors, an ignition apparatus and the like, and a hybrid vehicle is further equipped with a large-capacity power source, coils and the like, and these components generate pulse noises. For example, radio equipment described in Patent Document 1 passes a signal via an AD converter through a bandpass filter to limit a frequency band, passes the signal through a noise blanker to remove noises, and then passes the signal through a demodulator for demodulation. Also, for example, a receiver described in Patent Document 2 passes a signal via an AD converter through a wave detector for demodulation, and subsequently passes the signal through a noise gate to remove noises.
Patent Document 1: Japanese Patent Application Publication No. 2006-50016
Patent Document 2: Japanese Patent Application Publication No. 2012-191337
Non-Patent Document 1: Digital Design Technology No. 1, CQ Publishing Co., Ltd., 2009, p. 115

However, when the radio equipment as described in Patent Document 1 passes a radio wave with pulse noises through a bandpass filter, a filter delay occurs so that a width (i.e., a time width) of pulse noises included in the radio wave is extended in accordance with the number of taps which configure the filter. Therefore, when pulse noises are removed from a filtered signal, an extended zone is subject to removal, which leads to a problem of large-scale degradation of a signal wave. Note that the similar problem occurs for use of, not only a bandpass filter, but also a decimation filter described in Non-Patent Document 1. Also, the similar problem also occurs when the receiver as described in Patent Document 2 removes noises from a demodulated signal because a signal with noises is filtered prior to noise removal.

### SUMMARY

(Item 1)

A demodulator may include an AD conversion section that performs analogue-to-digital conversion on a received signal.

The demodulator may include a noise removal section that is connected to a back side of the AD conversion section to detect and remove a noise from an input signal.

The demodulator may include a first decimation filter that is connected to a back side of the noise removal section to reduce a data rate of an input signal.

The demodulator may include a demodulation section that is connected to a back side of the first decimation filter to demodulate an input signal.

(Item 2)

The demodulator may further include a second decimation filter that is connected to a back side of the AD conversion section and a front side of the noise removal section to reduce a data rate of an input signal.

(Item 3)

The demodulator may further include a third decimation filter that is connected to a back side of the demodulation section to reduce a data rate of an input signal.

(Item 4)

The noise removal section may include a zone detection section that detects a replacement target zone to be replaced in an input signal.

The noise removal section may include a replacement section that replaces a signal of the replacement target zone in an input signal with a replacement target signal.

(Item 5)

The zone detection section may include a high-pass filter that allows an input signal to pass therethrough.

The zone detection section may include a comparison section that detects the replacement target zone based on a result of comparing a signal from the high-pass filter with a reference value.

(Item 6)

The replacement section may include a low-pass filter that allows an input signal to pass therethrough and a signal passing through the low-pass filter is used as the replacement target signal.

(Item 7)

The AD conversion section may include an orthogonal frequency converter that converts a signal based on the received signal that is FM modulated to an I signal and a Q signal orthogonal to each other.

The AD conversion section may include an I-side AD converter that performs analogue-to-digital conversion on the I signal.

The AD conversion section may include a Q-side AD converter that performs analogue-to-digital conversion on the Q signal.

(Item 8)

The AD conversion section may include an AD converter that performs analogue-to-digital conversion on a signal based on the received signal that is FM modulated.

The AD conversion section may include an orthogonal frequency converter that converts an output of the AD converter to an I signal and a Q signal orthogonal to each other.

The summary clause does not necessarily describe all necessary features of the embodiments of the present invention. The present invention may also be a sub-combination of the features described above.

### BRIEF DESCRIPTION OF THE DRAWINGS

FIG. 1 shows a configuration of a demodulator according to the present embodiment.

FIG. 2 shows the configuration of the noise removal section.

FIG. 3A shows one example of an input signal to the noise removal section.

FIG. 3B shows one example of an output of the filter (HPF).

FIG. 3C shows one example of an output of the calculator (ABS).

FIG. 3D shows one example of a generation result of a reference value by the reference value generator.

FIG. 3E shows one example of a comparison result by the comparator.

FIG. 3F shows one example of an output of the pulse stretcher.

FIG. 3G shows one example of an output of the filter (LPF).

FIG. 3H shows one example of a result of noise processing (an output of the replacer) by the noise removal section.

FIG. 4 shows one example of a result of noise processing by the noise removal section according to the variant configuration.

FIG. 5 shows one example of an output (lower side) when a signal with a pulse noise (upper side) is passed through the decimation filter.

FIG. 6 shows the configuration of the demodulator according to the first variant example.

FIG. 7 shows the configuration of the demodulator according to the second variant example.

FIG. 8 shows the configuration the demodulator according to the third variant example.

### DESCRIPTION OF EXEMPLARY EMBODIMENTS

Hereinafter, the present invention is described through the embodiments of the invention. However, the following embodiments are not to limit the claimed invention. Also, all of combinations of features described in the embodiments are not necessarily required for the solution of the invention.

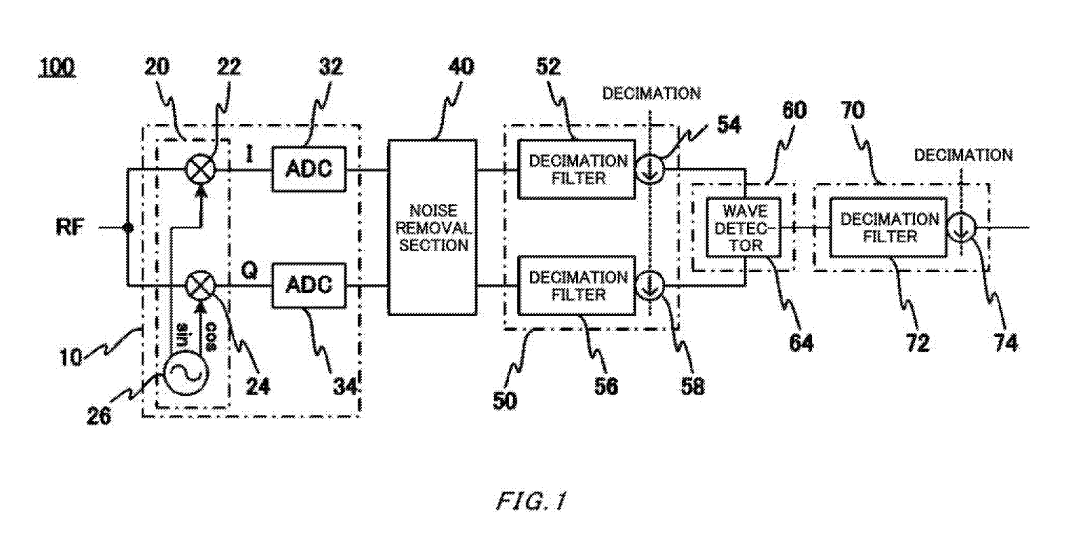

FIG. 1 shows the configuration of a demodulator 100 according to the present embodiment. The demodulator 100 is an apparatus that demodulates a signal modulated to a radio wave, and is designed to provide a demodulator less subject to degradation of a signal wave even when noise are removed using a noise blanker or other noise removal means. Note that in the present embodiment, it is assumed that the radio wave is FM modulated to V_{FM}=C sin (ω_{c}t+m ∫ₛdt) by changing a frequency of a carrier wave V_{c}=C sin (ω_{c}t) in accordance with amplitude of a signal wave Vₛ. Here, ω_{c}=2πf_{c} with a frequency of the carrier wave is f_{c}, and m is a constant.

The demodulator 100 includes an AD conversion section 10, a noise removal section 40, a first filter section 50, a demodulation section 60, and a second filter section 70.

The AD conversion section 10 converts, for example, a received signal RF in an analogue form, obtained by receiving a radio wave V_{FM} through an antenna, to a digital signal. The AD conversion section 10 includes an orthogonal frequency converter 20, and AD converters (ADCs) 32 and 34.

The orthogonal frequency converter 20 is a converter that converts the received signal RF to an I signal and a Q signal orthogonal to each other, and includes a local transmitter 26 and mixers 22 and 24. The local transmitter 26 generates two orthogonal local signals cos (ω_{c}t) and sin (ω_{c}t) having a frequency f_{c} and orthogonal to each other, and outputs the signals to the mixers 22 and 24, respectively. The mixer 22 mixes the received signal RF with the orthogonal signal sin (ω_{c}t) (i.e., multiplication) to generate the I signal (I=V_{FM} sin (ω_{c}t)), and outputs the signal to the AD converter 32 after it passes the signal through a filter (not shown) for removing unnecessary components. The mixer 24 multiplies the received signal RF by the orthogonal signal cos (ω_{c}t) to generate the Q signal (Q=V_{FM} cos (ω_{c}t)), and outputs the signal to the AD converter 34 after it passes the signal through a filter (not shown) for removing unnecessary components.

The AD converters 32 and 34 are connected to the mixers 22 and 24 to convert the I signal and the Q signal, input from the mixers 22 and 24, to digital signals, and output the signals to the filter section 40, respectively. Sampling rates of the AD converters 32 and 34 are sufficiently higher than an output frequency of the demodulation section 60, for example, twice or more to approximately 200 times. Thus, the AD converters 32 and 34 over sample input signals.

The noise removal section 40 is connected to a back side of the AD conversion section 10 to detect noises included in the I signal and the Q signal in a digital form input from the AD conversion section 10, and remove at least a portion of the detected noises. The detailed configuration of the noise removal section 40 is described below.

The first filter section 50 is connected to a back side of the noise removal section 40 to reduce data rates (i.e., down samples) of the I signal and the Q signal input from the noise removal section 40 from which noises are removed. The first filter section 50 includes decimation filters 52 and 56 and sampling frequency converters 54 and 58.

The decimation filters 52 and 56 receive the I signal and the Q signal from the noise removal section 40, cut portions of a high frequency band thereof, and output the signals to the sampling frequency converters 54 and 58, respectively. A low-pass filter can be used as the decimation filters 52 and 56. A cutoff frequency can be determined in accordance with down sampling rates of the sampling frequency converters 54 and 58 as appropriate.

The sampling frequency converters 54 and 58 are connected to the decimation filters 52 and 56 to down sample (convert or decimate sampling frequencies of) the I and Q signals, input from the filters 52 and 56, of which portions of the high frequency band are cut, respectively. The down sampling rates of the sampling frequency converters 54 and 58 are, for example, one half or less.

The first filter section 50 removes a component out of the band from the I signal and the Q signal by down sampling the I signal and the Q signal, and outputs the signals only with a signal wave component within the band to the demodulation section 60. Here, the decimation filters 52 and 56 cut portions of the high frequency band of the I signal and the Q signal, prior to down sampling by the sampling frequency converters 54 and 58, which can prevent aliasing due to down sampling.

The demodulation section 60 is connected to a back side of the first filter section 50 to demodulate the received signal RF using the I signal and the Q signal input from the filter section 50. The demodulation section 60 includes a wave detector 64 of an arc-tangent wave detection scheme. The wave detector 64 calculates an arc-tangent value θ=tan⁻¹ (Q/I) using the I signal and the Q signal, and further calculates a differential value thereof with a time differential dθ/dt or a difference. The wave detection result by the wave detector 64 is output to the second filter section 70.

The second filter section 70 is connected to a back side of the demodulation section 60 to down sample the wave detection result input from the demodulation section 60. The second filter section 70 includes a decimation filter 72 and a sampling frequency converter 74.

The decimation filter 72 receives the wave detection result of the demodulation section 60, cuts a portion of the high frequency band thereof, and outputs the result to the sampling frequency converter 74. A low-pass filter can be used as the decimation filter 72. A cutoff frequency can be determined in accordance with down sampling rates of the sampling frequency converter 74 as appropriate.

The sampling frequency converter 74 is connected to the decimation filter 72 to down sample (converts or decimates a sampling frequency of) the wave detection result, input from the decimation filter 72, of which a portion of the high frequency band is cut. The down sampling rate of the sampling frequency converter 74 is, for example, one half or less.

Here, in down sampling by the second filter section 70, the wave detection result is passed through the sampling frequency converter 74 via the decimation filter 72, which can prevent aliasing due to down sampling.

Note that, by using the first filter section 50 and the second filter section 70 in combination, signals that are over sampled by the AD converters 32 and 34 are reduced to correspond to a determined sampling rate. Accordingly, the down sampling rates of the first filter section 50 and the second filter section 70 are determined such that an inverse of the product thereof is equal to the sampling rates of the AD converters 32 and 34, respectively. For example, with respect to approximately 20 times the sampling rates of the AD converters 32 and 34, an inverse of the product of the respective down sampling rates of the first filter section 50 and the second filter section 70 is approximately one twentieth. Accordingly, for example, when signals that are over sampled only by the first filter section 50 are reduced to correspond to a determined sampling rate, the second filter section 70 is not necessarily provided.

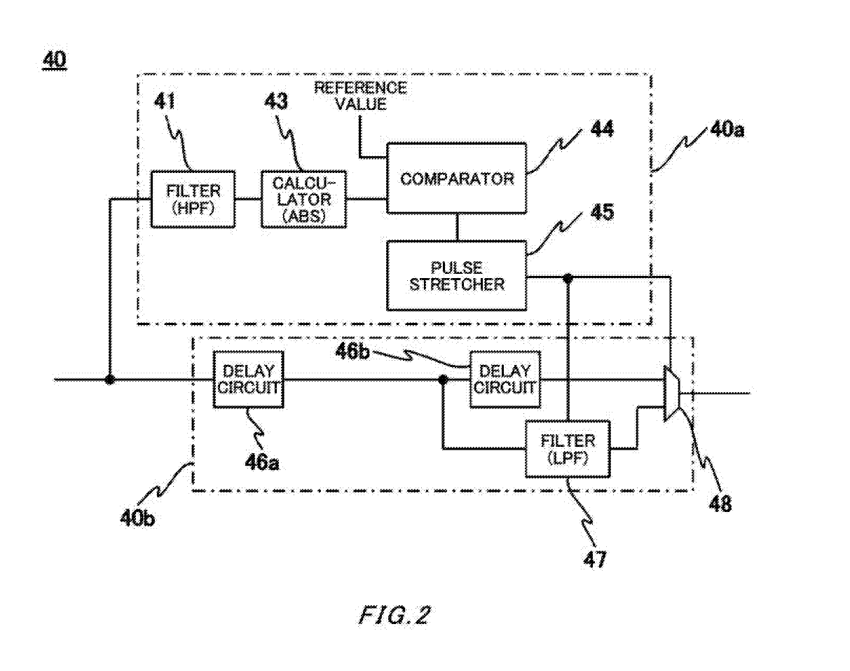

FIG. 2 shows the configuration of the noise removal section 40. In the present embodiment, a noise blanker is used as the noise removal section 40. The noise removal section 40 includes a zone detection section 40a and a replacement section 40b.

The zone detection section 40a compares a signal input to the noise removal section 40 (here, the I signal or the Q signal input from the AD conversion section 10 and simply referred to as an input signal) with a reference value, and based on the result, detects a replacement target zone (a so-called blanking zone) to be replaced in the input signal. The zone detection section 40a includes a filter 41, a calculator (ABS) 43, a comparator 44, and a pulse stretcher 45. The filter 41 includes a high-pass filter (HPF), cuts a portion of a low frequency band of the input signal using the high-pass filter, and outputs the signal to the calculator 43. The calculator (ABS) 43 is connected to the filter 41 to calculate an absolute value of a signal input from the filter 41 and output the result to the comparator 44. The comparator 44 is connected to the calculator 43 to compare a signal input from the calculator 43 with the reference value, and output the result to the pulse stretcher 45. The pulse stretcher 45 is connected to the comparator 44 to stretch a time width of a pulse signal included in a signal input from the comparator 44, and output the signal to the replacer 48 included in the replacement section 40b, as a replacement target zone signal indicating the replacement target zone.

Note that the zone detection section 40a may further include a reference value generator (not shown) that generates the reference value used by the comparator 44. The reference value generator generates, as one example, the reference value by detecting a peak of an output signal of the calculator 43 and adding an offset thereto. Here, in peak detection, a steep peak structure included in the output signal of the calculator 43 is detected. In a transient response to the peak structure, a small time constant is applied to the rise while a large time constant is applied to the decay, which results in a signal generated with a peak structure suppressed with respect to the output signal. Note that the offset is to be determined as appropriate in accordance with a level of a noise to be removed.

The replacement section 40b replaces a signal (input signal) of the replacement target zone in a signal input to the noise removal section 40 with a replacement target signal. The replacement section 40b includes delay circuits 46a and 46b, a filter 47, and a replacer 48. The delay circuit 46a delays an input signal and outputs the signal to the delay circuit 46b (and the filter 47). The delay circuit 46b further delays an input signal that is delayed by the delay circuit 46a, and outputs the signal to the replacer 48. The input signal is input to the replacer 48 by the delay circuits 46a and 46b in accordance with a timing at which the replacement target zone signal is input from the zone detection section 40a to the replacer 48. The filter 47 includes a low-pass filter (LPF), cuts a portion of the high frequency band of the input signal via the delay circuit 46a using the low-pass filter to generate the replacement target signal, and outputs the signal to the replacer 48. Here, a delay time of the delay circuit 46b is set equal to a delay time of the filter 47. This allows the filter 47 to input the replacement target signal to the replacer 48 in accordance with a timing at which the input signal is input to the replacer 48 via the delay circuits 46a and 46b. The replacer 48 replaces the input signal input from the delay circuit 46b with the replacement target signal generated by the filter 47, when the replacement target zone signal input from the zone detection section 40a is a logic high, that is, when the replacement target zone signal indicates the replacement target zone.

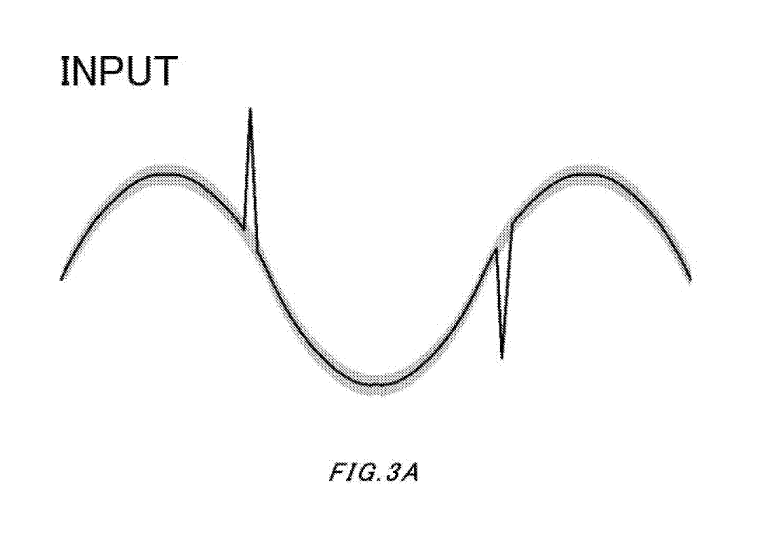

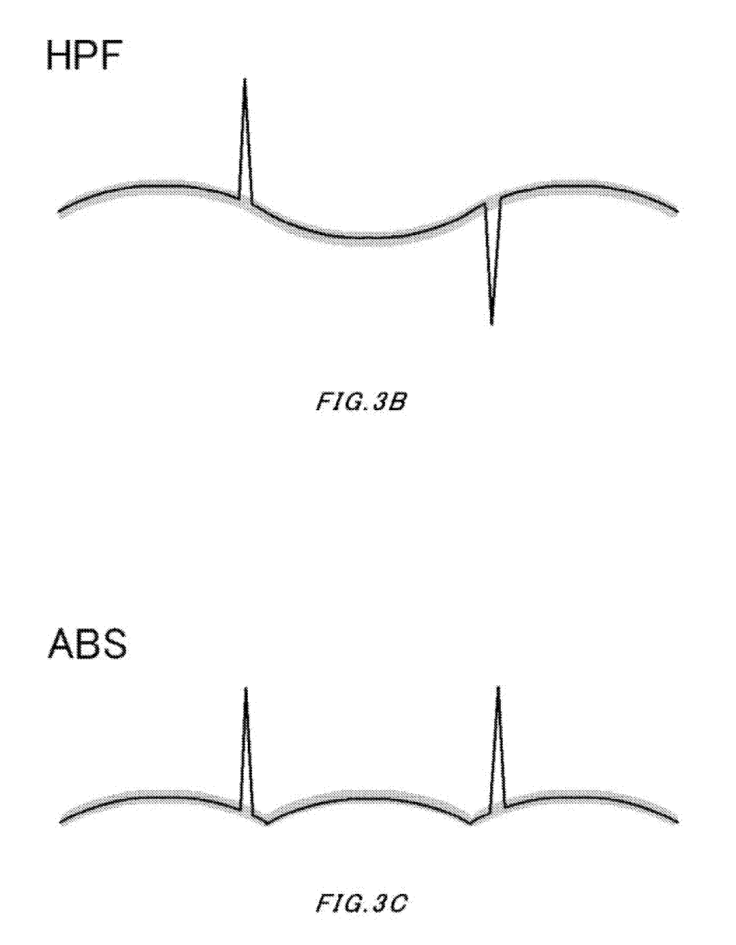

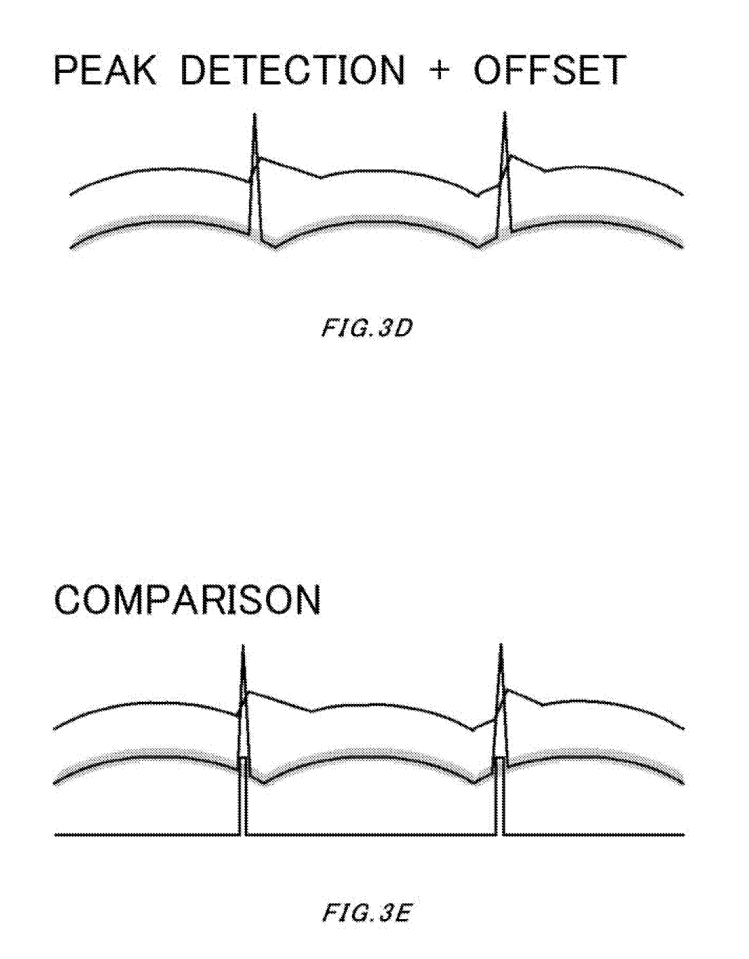

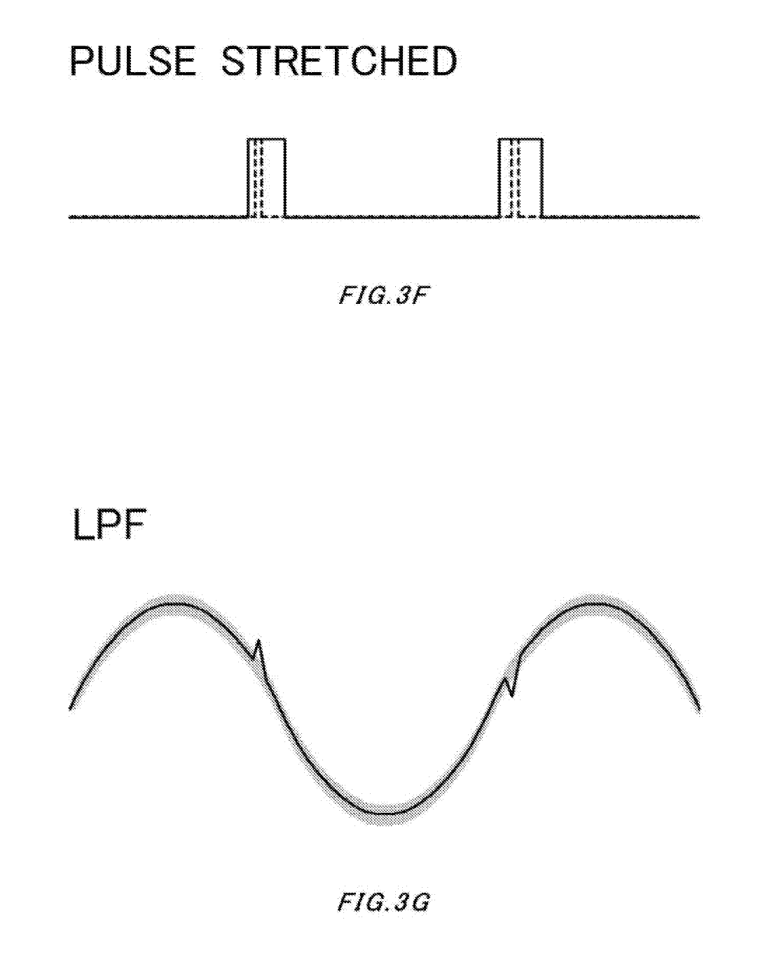

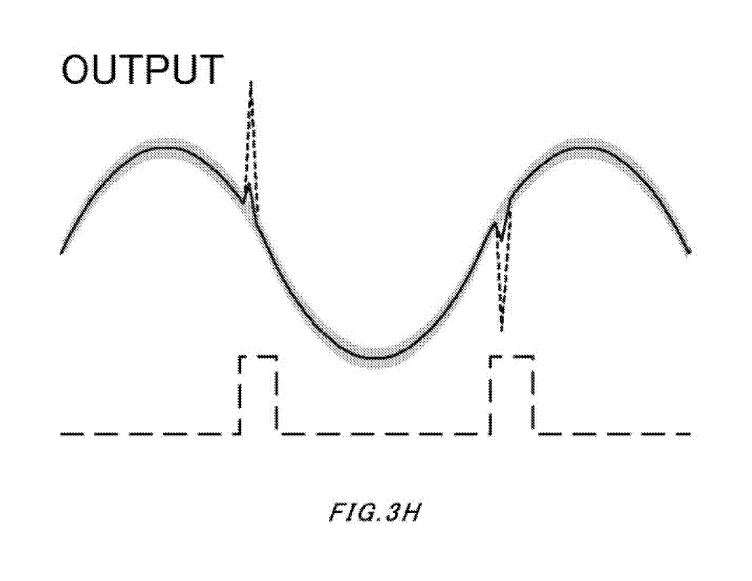

FIG. 3A to FIG. 3H show results of a series of processes by the noise removal section 40. FIG. 3A to FIG. 3H show signals obtained by each process (i.e., signal strengths are plotted on the vertical axis while times are on the horizontal axis), respectively.

FIG. 3A shows one example of a signal (input signal) input to the noise removal section 40. The input signal is to include two noises of a spiked shape having large amplitude on signal components of a carrier wave oscillating sinusoidally at frequency f_{c}.

FIG. 3B shows an output of the filter 41. The input signal (FIG. 3A) is passed through a high-pass filter (HPF) included in the filter 41 so that signal components included in the input signal which fall within the low frequency band are suppressed and the two noises are clearly extracted.

FIG. 3C shows an output of the calculator (ABS) 43. An absolute value of the output of the filter 41 (FIG. 3B) is generated by the calculator 43.

FIG. 3D shows a generation result of the reference value by the reference value generator (not shown). The reference value generator generates the reference value by detecting a peak of an output signal of the calculator 43 (FIG. 3C) and adding an offset to the result. The reference value is generated in this manner, so that the reference value can be determined appropriately for a largely fluctuating input signal. Note that when fluctuation of the input signal is small enough to be ignored, the reference value may be determined constant.

FIG. 3E shows a comparison result, by the comparator 44, of the output signal of the calculator 43 (FIG. 3C) with the reference value (FIG. 3D). When the output signal is higher than the reference value, a logic high pulse is generated. In this example, two pulses are generated to correspond to two noises.

FIG. 3F shows an output of the pulse stretcher 45, that is, the replacement target zone signal. By the pulse stretcher 45, time widths of the two pulses included in the output of the comparator 44 (FIG. 3E) are stretched back and forth.

FIG. 3G shows an output of the filter 47, that is, the replacement target signal. The input signal (FIG. 3A) is passed through the low-pass filter (LPF) included in the filter 47 (via the delay circuit 46a) so that two noises included in the input signal which fall within the high frequency band are suppressed.

FIG. 311 shows an output of the replacer 48, that is, the noise removal section 40. The replacement target zone signal (FIG. 3F) input, by the replacer 48, from the zone detection section 40a triggers the input signal input from the delay circuit 46b (FIG. 3A) to be replaced with the replacement target signal passing through the filter 47 (FIG. 3G), in the replacement target zone indicated by the replacement target zone signal.

Note that the demodulator 100 of the present embodiment removes noises by replacing the input signal with the replacement target signal generated by passing the input signal through the filter 47. Alternatively, the input signal may also be replaced with a value of a blank signal or an input signal immediately before the replacement target zone. In such a variant configuration, the replacer 48 (and the filter 47) may also be, for example, a D-type flip flop (not shown) which is triggered by the replacement target zone signal to hold the input signal input via the delay circuit 46a.

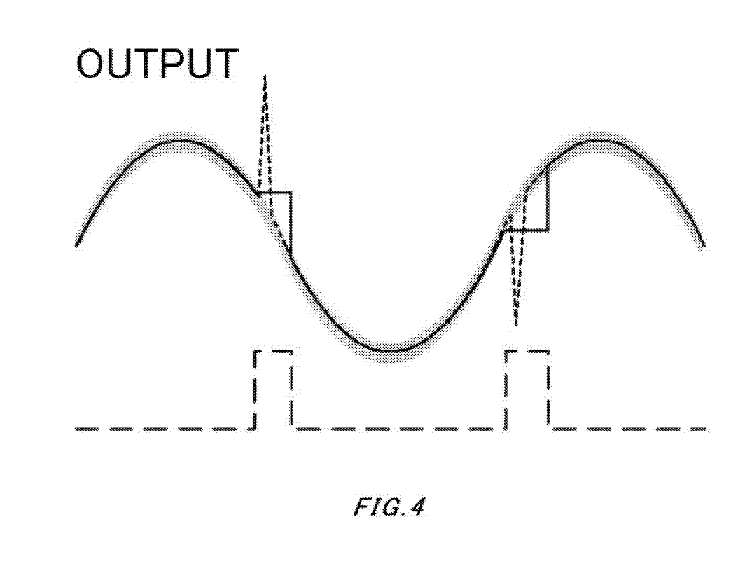

FIG. 4 shows a result of noise processing by the noise removal section according to the variant configuration. The input signal (FIG. 3A) is output with signal values, in the replacement target zone indicated by the replacement target zone signal (FIG. 3F), held to be a value before the zone by the D-type flip flop (not shown).

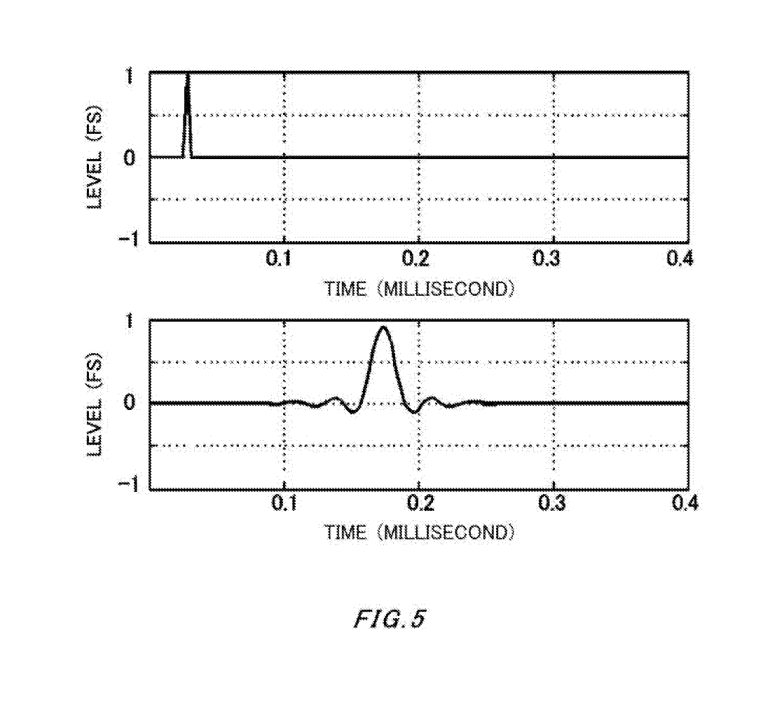

FIG. 5 shows one example of an output (lower side) when a signal with a pulse noise (upper side) is passed through the decimation filters 52 and 54. The signal includes a pulse noise having large amplitude from 0.02 to 0.03 milliseconds. When this signal is input to the decimation filters 52 and 54, in accordance with the number (in this example, about 100) of taps which configure the filter, a width of the noise is to be extended (in this example, about 10 times). Accordingly, if the first filter section 50 is connected to a front side of the noise removal section 40, a width of the noise included in the received signal RF is stretched by the decimation filters 52 and 54 included in the first filter section 50, a broad replacement target zone is detected by the noise removal section 40 in order to remove the noise, and the received signal is replaced with the replacement target signal in the broad zone, which results in original signal components largely degraded. On the other hand, in the demodulator 100 of the present embodiment, the first filter section 50 is connected to a back side of the noise removal section 40, which avoids such degradation of signal components.

In addition, the noise removal section 40 is connected to a back side of the AD conversion section 10. Here, the received signal RF is over sampled by the AD converters 32 and 34 so that the replacement target zone detected by the noise removal section 40 becomes narrow and the received signal RF is replaced with the replacement target signal in the narrow zone, which can minimize degradation of signal components.

Note that, the AD converters 32 and 34 included in the AD conversion section 10 over sample the received signal RF, and accordingly, three or more filter sections may be provided, and in particular, two or more filter sections may also be provided at a front side of the demodulation section 60 for down sampling.

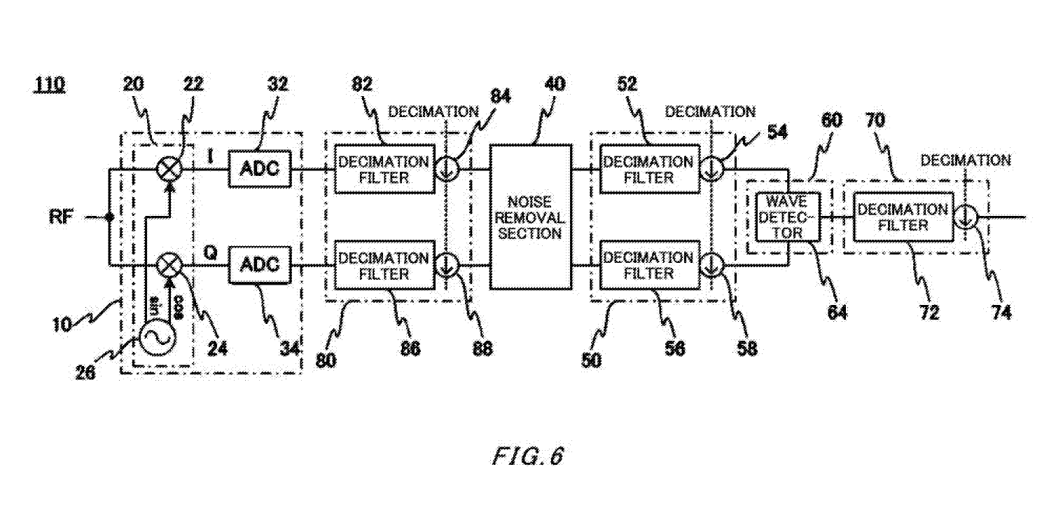

FIG. 6 shows the configuration of the demodulator 110 according to the first variant example. The demodulator 110 includes the AD conversion section 10, a third filter section 80, the noise removal section 40, the first filter section 50, the demodulation section 60, and the second filter section 70. The demodulator 110 has the same configuration as the demodulator 100 described above, except for the third filter section 80 connected to a back side of the AD conversion section 10 and a front side of the noise removal section 40. Hereinafter, only the third filter section 80 is described.

The third filter section 80 is connected between the AD conversion section 10 and the noise removal section 40 to down sample the I signal and the Q signal input from the AD conversion section 10, and output the signals to the noise removal section 40. The third filter section 80 includes decimation filters 82 and 86 and sampling frequency converters 84 and 88.

The decimation filters 82 and 86 receive the I signal and the Q signal from the AD conversion section 10, cut portions of the high frequency band thereof, and output the signals to the sampling frequency converters 84 and 88, respectively. A low-pass filter can be used as the decimation filters 82 and 86. A cutoff frequency can be determined in accordance with down sampling rates of the sampling frequency converters 84 and 88 as appropriate.

The sampling frequency converters 84 and 88 are connected to the decimation filters 82 and 86 to down sample (convert or decimate sampling frequencies of) the I and Q signals, input from the filters 82 and 86, of which portions of the high frequency band are cut, respectively. The down sampling rates of the sampling frequency converters 84 and 88 are, for example, one half or less.

In addition, one or more filter sections may also be connected serially to at least one of the first filter section 50, the second filter section 70, and the third filter section 80.

In this manner, three or more filter sections are provided, and in particular, two or more filter sections are provided at a front side of the demodulation section 60 for down sampling in combination, which allows a simple configuration of the filter section to down sample the over sampled I and Q signals. In such a case, the noise removal section 40 is desired to be connected to front sides of all of the filter sections, and at a front side of the demodulation section 60, is at least connected to a front portion of at least one of the filter sections. This allows the demodulation section 60 to demodulate a signal wave, after the decimation filter included in the filter section connected to a back portion of the noise removal section 40 cuts harmonic noise components which may be taken in due to noise blank by the noise removal section 40.

Note that the AD converters 32 and 34 included in the AD conversion section 10 may also be replaced with one AD converter.

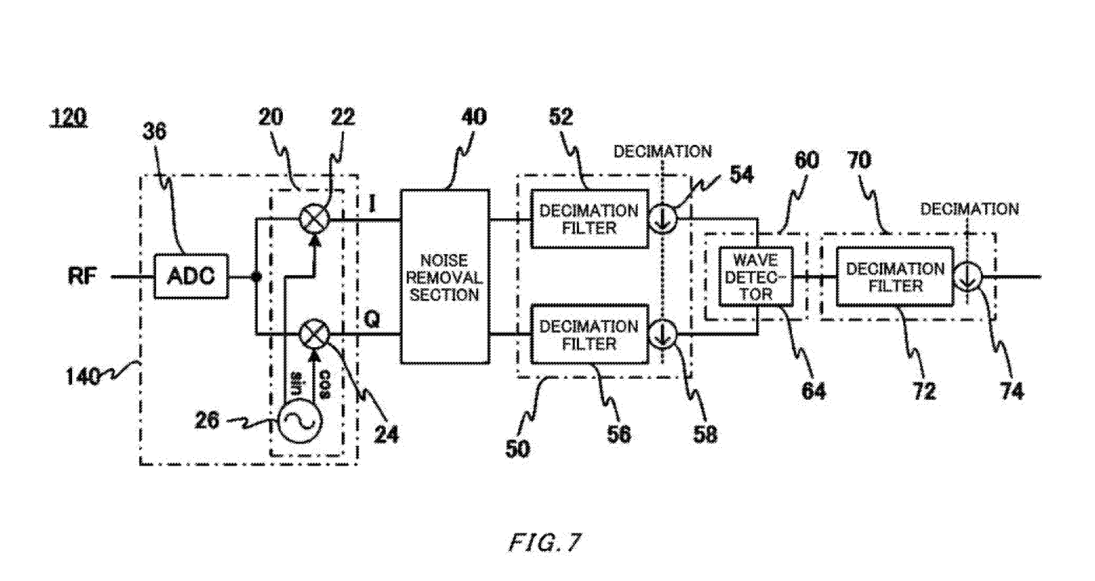

FIG. 7 shows the configuration of the demodulator 120 according to the second variant example. The demodulator 120 includes an AD conversion section 140, the noise removal section 40, the first filter section 50, the demodulation section 60, and the second filter section 70. Note that each constituent other than the AD conversion section 140 has the same configuration as that of the demodulator 100 described above. Hereinafter, only the AD conversion section 140 is described.

The AD conversion section 140 includes an AD converter (ADC) 36 and the orthogonal frequency converter 20. Note that the configuration of the orthogonal frequency converter 20 is the same as the one described above. The AD converter (ADC) 36 is connected to a front side of the orthogonal frequency converter 20 to convert the received signal RF in an analogue form to a digital signal, and output the signal to the mixers 22 and 24 included in the orthogonal frequency converter 20, respectively. A sampling rate of the AD converter 36 can be determined in a similar manner to those of the AD converters 32 and 34.

Note that the AD conversion section 140 may further include a mixer (not shown) connected to a front side of the AD converter 36. The mixer mixes the received signal RF in an analogue form with an output of a local oscillator (not shown) to lower a frequency to a frequency a bit higher than DC (referred to as a DC frequency), for example, to approximately hundreds of kHz. A signal generated in such a manner is referred to as a Low-IF signal. The AD conversion section 140 passes the Low-IF signal through the AD converter 36 to convert it to a digital signal, passes the converted Low-IF signal through the orthogonal frequency converter 20 to generate the I signal and the Q signal at the DC frequency.

In the demodulator 120, the noise removal section 40 is also connected to front sides of the first filter section 50 and the second filter section 70. This prevents a signal of which a noise width included in the received signal RF is stretched by the decimation filter from being input to the noise removal section 40, which prevents degradation of signal components due to noise blank over a broad replaced zone.

Note that the demodulator 100 described above generates the I signal and the Q signal from the received signal RF, and after passing them through the noise removal section 40 and the first filter section 50, demodulates the signals by the wave detector 64 included in the demodulation section 60. Alternatively, it may also use a Hilbert converter to further pass the received signal RF through the Hilbert converter after passing the signal through the noise removal section 40 and the first filter section 50, and subsequently demodulate the signal by the wave detector 64.

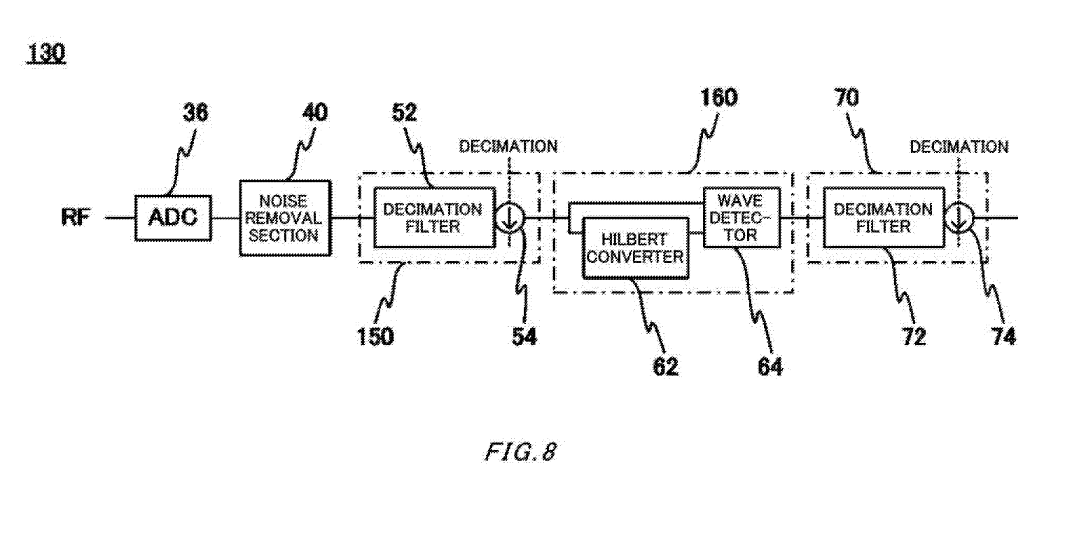

FIG. 8 shows the configuration of the demodulator 130 according to the third variant example. The demodulator 130 includes the AD converter (ADC) 36, the noise removal section 40, a first filter section 150, a demodulation section 160, and the second filter section 70.

The AD converter (ADC) 36 converts the received signal RF in an analogue form to a digital signal and outputs the signal to the noise removal section 40. A sampling rate of the AD converter 36 can be determined in a similar manner to those of the AD converters 32 and 34.

The noise removal section 40 is connected to a back side of the AD converter 36 to process the received signal RF input from the AD converter 36 to remove noises, and output the signal to the first filter section 150.

The first filter section 150 is connected to the noise removal section 40 to down sample the received signal RF from which noises are removed and output the signal to the demodulation section 160. The first filter section 150 includes one decimation filter 52 and one sampling frequency converter 54. The decimation filter 52 and the sampling frequency converter 54 are configured in a similar manner to those of the demodulator 100 described above.

The demodulation section 160 demodulates the received signal RF using Hilbert conversion. The demodulation section 160 includes a Hilbert converter 62 and a wave detector 64. The Hilbert converter 62 delays a phase of the received signal RF input from the first filter section 150 by 90 degrees and inputs the signal to the wave detector 64. The wave detector 64 performs wave detection by arc-tangent wave detection, using the received signal RF input from the first filter section 150 and the delayed signal input from the Hilbert converter 62. The wave detection result is output to the second filter section 70.

The second filter section 70 is connected to a back side of the demodulation section 160 to down sample the wave detection result input from the demodulation section 160 and output the signal as the demodulated signal. The second filter section 70 is configured in a similar manner to that of the second filter section 70 of the demodulator 100 described above.

The demodulation section 160 demodulates the received signal RF using Hilbert conversion so that the noise removal section 40 and the first filter section 50 of a two-channel configuration in the demodulator 100 can be replaced with the noise removal section 40 and the first filter section 150 of a one-channel configuration in the demodulator 130 according to the present variant example.

Note that, although the demodulator 100 according to the present embodiment and the demodulators 110, 120, and 130 according to the variant examples are described as demodulators that demodulate the FM modulated radio wave, they are not limited thereto, but may also be demodulators that demodulate an AM modulated, PM modulated, FSK modulated, ASK modulated, or PSK modulated radio wave.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As can be understood clearly from the description above, the demodulator can be realized according to an (one) embodiment of the present invention.

What is claimed is:

1. A demodulator comprising:
an AD conversion section that performs analogue-to-digital conversion on a received signal;
a noise removal section that is connected to a back side of the AD conversion section to detect and remove a noise from an input signal;
a first decimation filter that is connected to a back side of the noise removal section to reduce a data rate of an input signal; and
a demodulation section that is connected to a back side of the first decimation filter to demodulate an input signal.

2. The demodulator according to claim 1, further comprising a second decimation filter that is connected to a back side of the AD conversion section and a front side of the noise removal section to reduce a data rate of an input signal.

3. The demodulator according to claim 1, further comprising a third decimation filter that is connected to a back side of the demodulation section to reduce a data rate of an input signal.

4. The demodulator according to claim 1, wherein the noise removal section includes:
a zone detection section that detects a replacement target zone to be replaced in an input signal; and
a replacement section that replaces a signal of the replacement target zone in an input signal with a replacement target signal.

5. The demodulator according to claim 4, wherein the zone detection section includes:
a high-pass filter that allows an input signal to pass therethrough; and
a comparison section that detects the replacement target zone based on a result of comparing a signal from the high-pass filter with a reference value.

6. The demodulator according to claim 4, wherein the replacement section includes a low-pass filter that allows an input signal to pass therethrough, and wherein a signal passing through the low-pass filter is used as the replacement target signal.

7. The demodulator according to claim 1, wherein the AD conversion section includes:
an orthogonal frequency converter that converts a signal based on the received signal that is FM modulated to an I signal and a Q signal orthogonal to each other;
an I-side AD converter that performs analogue-to-digital conversion on the I signal; and
a Q-side AD converter that performs analogue-to-digital conversion on the Q signal.

8. The demodulator according to claim 1, wherein the AD conversion section includes:
an AD converter that performs analogue-to-digital conversion on a signal based on the received signal that is FM modulated; and
an orthogonal frequency converter that converts an output of the AD converter to an I signal and a Q signal orthogonal to each other.
